(19) United States
(12) Patent Application Publication
(10) Pub. No.: US 2001/0006422 A1
(43) Pub. Date: Jul. 5, 2001

(54) Stage system in projection exposure apparatus

(76) Inventors: Youzou Fukagawa, Kawachi-gun (JP); Shuichi Yabu, Kawasaki-shi (JP)

Correspondence Address: FITZPATRICK CELLA HARPER & SCINTO, 30 ROCKEFELLER PLAZA, NEW YORK, NY, 10112, US

(21) Appl. No.: 09/726,593

(22) Filed: Dec. 1, 2000

(30) Foreign Application Priority Data
Dec. 1, 1999 (JP) 11-342199

(51) Int. Cl. G01B 9/02

(52) U.S. Cl. 356/500

(57) ABSTRACT

A stage system includes a movable stage, a gas blowing port for blowing a gas in a predetermined direction, a mirror disposed on the stage, a laser interferometer for projecting measurement light to the mirror, to measure a position of the stage, and a member disposed between the gas blowing port and a measurement light path of the laser interferometer, to block a portion of a gas flow from the gas blowing port. This arrangement enables reduction of an interferometer error caused by any fluctuation of an air, without disturbing the stage motion.

### FIELD OF THE INVENTION AND RELATED ART

This invention relates to a stage system for use in a projection exposure apparatus, for example, wherein a circuit pattern on an original such as a reticle is illuminated with illumination light and it is transferred to a wafer through a projection optical system.

More particularly, the present invention concerns a stage system suitably usable in production of semiconductor devices such as ICs or LSIs, for example. It is usable in an exposure apparatus, called a stepper, wherein an electronic circuit pattern formed on the surface of a reticle is projected through a projection optical system onto the surface of a wafer sequentially by a step-and-repeat process. Also, it is usable in an exposure apparatus, called a scanner, wherein an electronic circuit pattern formed on the surface of a reticle is projected through a projection optical system onto the surface of a wafer by a step-and-scan process. With the stage system according to the present invention, an error in a stage position measuring interferometer, caused by any fluctuation of a gas flow, flowing around the stage, can be reduced such that a high precision semiconductor exposure apparatus can be accomplished.

Projection exposure apparatuses are required to have a high stage positioning precision, and laser interferometers are used for the position measurement. However, the laser interferometer involves an inconvenience that it is easily influenced by an atmospheric pressure in the space, or the temperature or humidity thereof. Further, an air flow directly crosses the optical path of the laser interferometer, and many measurement noises are easily mixed. This may be caused by that an air, having fluctuation (flickering) due to temperature non-uniformness in surrounding components, flows into the optical path of the interferometer.

A first example to meet this problem is a method disclosed in U.S. Pat. No. 5,875,031. More specifically, as shown in FIGS. 10A and 10B, there are expandable/contractible covers 10-1 and 10-2 around the optical paths of first and second interferometers 1 and 2. Alternatively, two parallel flat plates may be used to sandwich the interferometer light paths 3 and 4. This is to stabilize the state of the air. The structure has to be made expandable and contractible to prevent mechanical interference with a stage 5 which is movable. To this end, one end of the cover is fixed to the movable stage 5, while the other end is fixed to a base 8. The cover may have a bellows expandable/contractible structure or it may have a sliding mechanism at a center thereof. In FIGS. 10A and 10B, denoted at 1 is an interferometer for a first axis, and denoted at 2 is another interferometer for a second axis. Denoted at 6 is a reflection mirror for the first-axis interferometer, and denoted at 7 is a reflection mirror for the second-axis interferometer. There are a gas inlet port and a gas outlet port defined inside each cover 10-1 or 10-2, such that air flows inside the cover.

A second example to meet the above-described problem is a method, as shown in Japanese Laid-Open Patent Application, Laid-Open No. 126522/1993, wherein an air having its temperature or humidity controlled constant is discharged locally toward a portion of the light path of an interferometer.

The first method described above involves an inconvenience that the stage movement based on a non-contact structure is disturbed. In the second method, on the other hand, the local air discharging described above differs from flowing an air for temperature stabilization of a wafer or a mirror on the stage, in respect to the path, for example. This means that the temperature and the flow rate can not be made exactly the same. Rather, it has a possibility that the fluctuation increases around the light path of the interferometer. As a result, the noise mixture can not always be reduced.

### SUMMARY OF THE INVENTION

It is an object of the present invention to solve the problems involved in the first and second methods described above, and to reduce an interferometer error due to fluctuation of an air without disturbing the stage motion and to reduce the noise mixture into the interferometer.

In accordance with an aspect of the present invention, there is provided a stage system, comprising: a movable stage; a gas blowing port for blowing a gas in a predetermined direction; a mirror disposed on said stage; a laser interferometer for projecting measurement light to said mirror, to measure a position of said stage; and a member disposed between said gas blowing port and a measurement light path of said laser interferometer, to block a portion of a gas flow from said gas blowing port.

The member may be operable to stabilize fluctuation at the measurement light path of said laser interferometer.

The stage may move in an ambience in which a gas is blown in a predetermined direction.

The gas blowing port may function to flow a gas in a direction out of parallel to a plane along which said stage is movable.

The member may be operable to prevent that the gas flow from said gas blowing port directly flows into the measurement light path.

The member may have one of a semi-cylindrical shape and a planar shape.

The member may have a bore.

The member may have one of a structure defined by a combination of fine tubular elements and a structure having partitions defined by flat plates.

The flow rate of a gas flow across the measurement light path of said laser interferometer may be smaller than that of a gas flow in an ambience.

The direction of the gas flow from said gas blowing port may be inclined with respect to a plane along which said stage is movable.

In accordance with another aspect of the present invention, there is provided a stage system, comprising: a movable stage; a gas blowing port for blowing a gas in a predetermined direction; a mirror disposed on said stage; a laser interferometer for projecting measurement light to said mirror, to measure a position of said stage; and a member arranged to produce a difference between a flow rate of a gas flow in an ambience as provided by said gas blowing port and a flow rate of a gas flow across a measurement light path of said laser interferometer.

In this aspect of the present invention, the member may be operable to stabilize fluctuation at the measurement light path of said laser interferometer.

The stage may move in an ambience in which a gas is blown in a predetermined direction.

The gas blowing port may function to flow a gas in a direction out of parallel to a plane along which said stage is movable.

The member may be operable to prevent that the gas flow from said gas blowing port directly flows into the measurement light path.

The member may have one of a semi-cylindrical shape and a planar shape.

The member may have a bore.

The member may have one of a structure defined by a combination of fine tubular elements and a structure having partitions defined by flat plates.

The flow rate of a gas flow across the measurement light path of said laser interferometer may be smaller than that of a gas flow in an ambience.

The direction of the gas flow from said gas blowing port may be inclined with respect to a plane along which said stage is movable.

In accordance with a further aspect of the present invention, there is provided a stage system, comprising: a movable stage; a gas blowing port for blowing a gas in a predetermined direction; a mirror disposed on said stage; a laser interferometer for projecting measurement light to said mirror, to measure a position of said stage; and a member disposed between said gas blowing port and a measurement light path of said laser interferometer, wherein said member has a temperature adjusted structure.

In this aspect of the present invention, the member may be adjusted at a constant temperature.

The member may be operable to stabilize fluctuation at the measurement light path of said laser interferometer.

The stage may move in an ambience in which a gas is blown in a predetermined direction.

The gas blowing port may function to flow a gas in a direction out of parallel to a plane along which said stage is movable.

The member may be operable to prevent that the gas flow from said gas blowing port directly flows into the measurement light path.

The member may have one of a semi-cylindrical shape and a planar shape.

The member may have a bore.

The member may have one of a structure defined by a combination of fine tubular elements and a structure having partitions defined by flat plates.

The flow rate of a gas flow across the measurement light path of said laser interferometer may be smaller than that of a gas flow in an ambience.

The direction of the gas flow from said gas blowing port may be inclined with respect to a plane along which said stage is movable.

In accordance with a yet further aspect of the present invention, there is provided an exposure apparatus, comprising: a movable stage; a gas blowing port for blowing a gas in a predetermined direction; a mirror disposed on said stage; a laser interferometer for projecting measurement light to said mirror, to measure a position of said stage; and a member disposed between said gas blowing port and a measurement light path of said laser interferometer, to block a portion of a gas flow from said gas blowing port.

In accordance with a still further aspect of the present invention, there is provided an exposure apparatus, comprising: a movable stage; a gas blowing port for blowing a gas in a predetermined direction; a mirror disposed on said stage; a laser interferometer for projecting measurement light to said mirror, to measure a position of said stage; and a member arranged to produce a difference between a flow rate of a gas flow in an ambience as provided by said gas blowing port and a flow rate of a gas flow across a measurement light path of said laser interferometer.

In accordance with a yet further aspect of the present invention, there is provided an exposure apparatus, comprising: a movable stage; a gas blowing port for blowing a gas in a predetermined direction; a mirror disposed on said stage; a laser interferometer for projecting measurement light to said mirror, to measure a position of said stage; and a member disposed between said gas blowing port and a measurement light path of said laser interferometer, wherein said member has a temperature adjusted structure.

In accordance with a still further aspect of the present invention, there is provided a device manufacturing method, comprising the steps of: preparing an exposure apparatus as recited above; and exposing a substrate by use of the exposure apparatus.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1A and 1B schematically show a stage system according to a first embodiment of the present invention, wherein FIG. 1A is a plan view and FIG. 1B is a front view.

FIG. 2 is a perspective view for explaining a fluctuation stabilizing device according to a second embodiment of the present invention.

FIGS. 3A and 3B schematically show a stage system according to a third embodiment of the present invention, wherein FIG. 3A is a plan view and FIG. 3B is a front view.

FIGS. 4A and 4B are schematic views, respectively, for explaining a laminar flow producing structure according to the third embodiment of the present invention.

FIGS. 5A and 5B are schematic views, respectively, for explaining a laminar flow producing structure according to a fourth embodiment of the present invention.

FIGS. 6A and 6B schematically show a stage system according to a fifth embodiment of the present invention, wherein FIG. 6A is a plan view and FIG. 6B is a front view.

FIG. 7 is a front view of an embodiment of a scan type exposure apparatus wherein a stage system according to the present invention is incorporated as a stage.

FIG. 8 is a flow chart of semiconductor device manufacturing processes, when the exposure apparatus of FIG. 7 is used.

FIG. 9 is a flow chart for explaining details of a wafer process included in the procedure of FIG. 8.

FIGS. 10A and 10B show a conventional stage system, wherein FIG. 10A is a plan view and FIG. 10B is a front view.

### DESCRIPTION OF THE PREFERRED EMBODIMENTS

Preferred embodiments of the present invention will now be described with reference to the accompanying drawings.

In the present invention, a stage may move in an ambience in which a gas is blown in a predetermined direction. In a direction not coinciding with a plane along which the stage moves, an air having a temperature or humidity kept constant may be blown. A fluctuation stabilizing device may be provided so as to prevent that an air directly flows into an interferometer light path, and it may preferably be disposed at a position not disturbing the stage motion and being close to the light path of a first-axis interferometer. A gas blowing port may desirably flow a gas in a direction out of parallel to the plane along which the stage is movable. The fluctuation stabilizing device may desirably function to prevent the gas, from the gas blowing port, from directly flowing into the measurement light path. It may have a semi-cylindrical shape or a planar shape. It may have fine bores formed in the whole surface thereof. It may have a structure of a combination of fine tubular elements or a structure having partitions defined by flat plates. The flow rate of the gas flow across the measurement light path of a laser interferometer may desirably be smaller than that of the gas flow in the ambience. The direction of the gas flow from the gas blowing port may be inclined with respect to the plane along which the stage is movable.

### [First Embodiment]

FIGS. 1A and 1B show a stage system according to a first embodiment of the present invention, wherein FIG. 1A is a plan view and FIG. 1B is a side view. As shown in these drawings, the stage system comprises an interferometer 1 for a first axis, another interferometer 2 for a second axis, a stage 5, a reflection mirror 6 for the first-axis interferometer 1, another reflection mirror 7 for the second-axis interferometer 2, a stage base 7, a windshield 12 as a fluctuation stabilizer, and a gas blowing port 13.

In the stage system, an air having a temperature and a humidity controlled to a constant level is forcibly blown, from the gas blowing port 13 in a constant direction, into the space which includes a range for the movable stroke of the stage 5 as well as the interferometer light path 3 of the interferometer 1 and the interferometer light path 4 of the interferometer 2. With this gas blowing, the temperature of a wide portion of the structure, including a wafer on the stage 5, the mirrors 6 and 7 as well as the laser interferometer light paths 3 and 4 and the stage base 8 (thus not limited to the interferometer light paths 3 and 4 as measurement light paths), can be maintained constant.

The windshield 12 has a semi-cylindrical shape wherein a convex surface thereof faces to the gas blowing port 13 while a concave surface thereof faces to the interferometer light path 3. It is held substantially horizontally, at the lower end of a holding member 18 which suspends from an upper fixed member 17. The windshield 12 is provided between the gas blowing port 13 and the interferometer light path 3 which extends perpendicularly to the blowing direction of the gas 19 blown from the gas blowing port 13. Further, the windshield 12 is disposed substantially in parallel to the interferometer light path 3, as shown in FIG. 1A, to cover the whole of the interferometer light path 3 against the gas blowing port. Thus, it functions to block at least a portion of the gas flow, with respect to the light path 3, to thereby prevent the gas flow from the gas blowing port 13 from directly entering the interferometer light path 3. Also, the windshield 12 is kept at a constant temperature, by means of the gas flow from the gas blowing port 13. The gas flow entering the interferometer light path 3 of the laser interferometer is weakened, such that the flow rate of the gas flow crossing the measurement light along the light path 3 is made smaller than the flow rate of the gas flow inside the ambience.

The gas blowing port 13 is disposed obliquely above the interferometer light paths 3 and 4, and it is formed with such tilt angle that the position moves up as becoming closer to the horizontal plane along which the stage 5 is movable. With this structure, the air flowing into the first-axis interferometer light path 3 flows thereinto obliquely from the above. Therefore, the windshield 12 placed adjacent to the light path 3 can well function to prevent the the blown air from directly flowing into the light path 3.

In this embodiment, a windshield is provided as a fluctuation stabilizer for stabilizing fluctuation just before an air, having fluctuation, enters the interferometer light path. Here, the windshield is provided by a member having a suitable heat capacity and a suitable heat conductivity. By flowing airs adjacent this member, the temperature distribution thereof can be made moderate.

### [Second Embodiment]

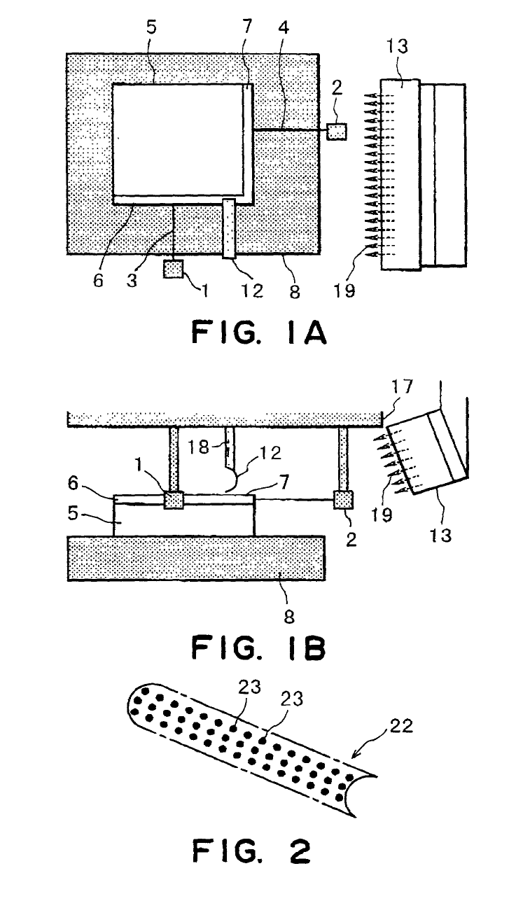

FIG. 2 is a perspective view of a windshield in a stage system according to a second embodiment of the present invention. In order to reduce the air resistance of the windshield 12 of the first embodiment, the windshield 22 of this embodiment is arranged so that a number of fine bores 23 of uniform size are formed in the whole surface of semi-cylindrical member. This windshield 22 may preferably be used in a case where the flow rate of a gas from a gas blowing port 13 is slow. Also in this embodiment, the windshield can function to make moderate the temperature distribution due to fluctuation of airs, like the preceding embodiment.

### [Third Embodiment]

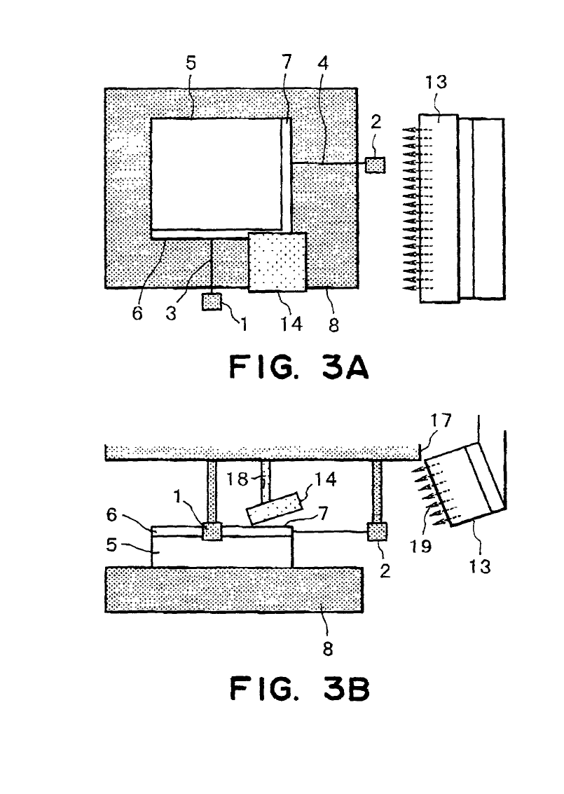

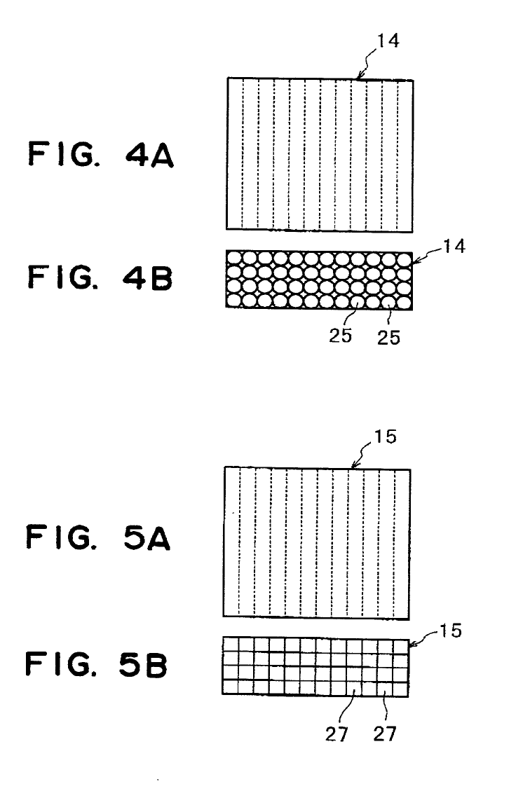

FIGS. 3A and 3B show a stage system according to a third embodiment of the present invention. The same reference numerals as those of FIGS. 1A and 1B are assigned to corresponding elements. FIG. 3A is a plan view, and FIG. 3B is a side view. In place of the windshield 12 of the first embodiment, the stage system of this embodiment uses a laminar flow producing structure 14 (FIGS. 4A and 4B) which comprises a combination of a fine tubular elements 25 disposed along a direction parallel to the flow of the blown air. This structure may desirably be used in a case wherein a laminar flow of a blown gas is preferred. Also in this embodiment, the windshield well functions to make moderate the temperature distribution due to fluctuation of airs, like the preceding embodiments.

### [Fourth Embodiment]

FIGS. 5A and 5B show a windshield in a stage system according to a fourth embodiment of the present invention, wherein FIG. 5A is a plan view and FIG. 5B is a side view. In place of the fine tube bundle 25 of the third embodiment, the windshield of this embodiment uses a laminar flow producing structure 15 having partitions defined by flat plates 27. Also in this embodiment, the windshield well functions to make moderate the temperature distribution due to the fluctuation of airs, like the preceding embodiments.

### [Fifth Embodiment]

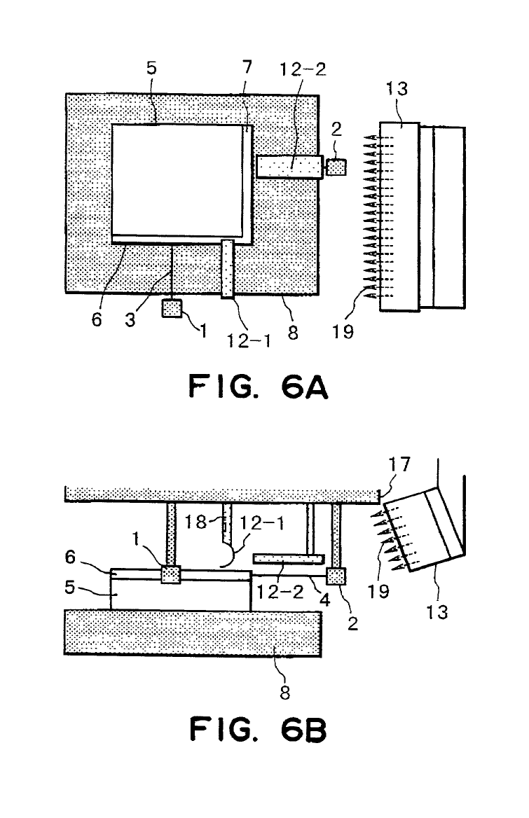

FIGS. 6A and 6B show a stage system according to a fifth embodiment of the present invention. Like numerals as those of FIGS. 1A and 1B are assigned to corresponding elements. FIG. 6A is a plan view, and FIG. 6B is a side view. This stage system differs from the preceding embodiments in that a windshield 12-1 is provided at the light path 3 of the interferometer 1 and also another windshield 12-2 is provided at the interferometer light path 4 of the interferometer 2.

The windshield 12-2 has a semi-cylindrical shape with a uniform section. As shown in FIG. 6A, it is disposed substantially in parallel to the interferometer light path 4, with its convex surface placed facing up toward the gas blowing port 13, and with its concave surface placed facing down toward the light path 4. It covers the whole of the interferometer light path 4 against the gas blowing port 13, to prevent the gas flow, from the gas blowing port 13, from directly entering the interferometer light path 4. Also, the windshield 12-2 is kept at a constant temperature, by means of the gas flow from the gas blowing port 13. With this windshield, the gas flow entering the interferometer light path 4 of the laser interferometer 2 is weakened, such that the flow rate of the gas flow across the measurement light of the interferometer light path 4 can be made smaller than the flow rate of the gas flow inside the ambience.

In accordance with this embodiment, also the interferometer light path 4 of the interferometer 2 is provided with a windshield 12-2. As a result, not only the noise mixture into the interferometer 1 but also the noise mixture into the interferometer 2 can be reduced. Therefore, there is an additional advantage of further increase in precision of the exposure apparatus, for example.

The present invention is not limited to the above-described embodiments, and various modifications and alterations are possible. For example, keeping the temperature of the windshield constant is not limited to use of the gas flow from the gas blowing port 13. The windshield may be provided with a temperature adjusting device to positively adjust the temperature thereof. Further, the windshield 12-2 shown in FIG. 6 may have fine bores such as those shown in FIG. 2. In place of a semi-cylindrical shape, a flat plate or a plate with bores may be used. Further, a laminar flow producing structure 14 or 15 shown in FIGS. 4A and 4B or 5A and 5B, or one similar to it, may be used.

In the embodiments described above, a gas is flown in a direction parallel to X direction (or Y direction). However, the invention is not limited to it. A gas may be flown in an oblique direction with respect to the X direction (or Y direction). In that case, both of the interferometer light paths of the first-axis and second-axis interferometers may preferably be provided with windshields.

### [Embodiments of Exposure Apparatus and Device Manufacturing Method]

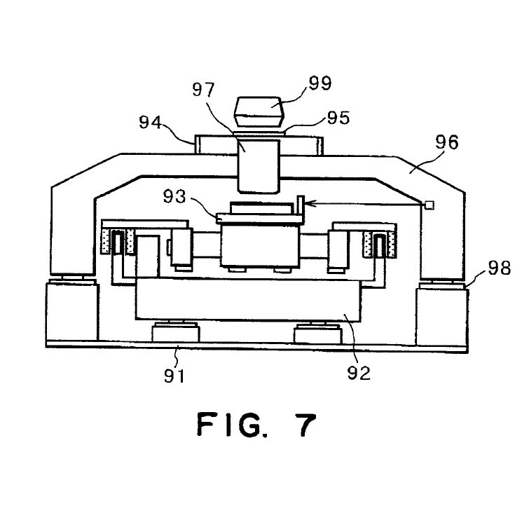

Referring to FIG. 7, an embodiment of a scan type exposure apparatus in which a stage system according to any one of the preceding embodiments of the present invention is incorporated as a stage, will be explained. A barrel base 96 is supported by a floor or a base table 91 through dampers 98. The barrel base 96 functions to support a reticle base 94 and also to support a projection optical system 97 which is disposed between a reticle stage 95 and a wafer stage 93.

The wafer stage 93 is supported on a stage base 92 which is supported by the floor or the base table 91, and it functions to position a wafer carried thereon. The reticle stage 95 is supported on a reticle stage base 94 which is supported by the barrel base 96. It is movable while carrying thereon a reticle having a circuit pattern formed thereon. An illumination optical system 99 produces exposure light with which a wafer placed on the wafer stage 93 can be exposed to the reticle placed on the reticle stage 95. The wafer stage 93 is scanningly moved in synchronism with the reticle stage 95. During the scan motion of the reticle stage 95 and the wafer stage 93, the positions of them are continuously detected by means of respective interferometers, and the detected positions are fed back to driving units for the reticle stage 95 and the wafer stage 93, respectively. With this arrangement, the scan start positions of these stages can be synchronized with each other correctly and, additionally, the scan speed of them in the constant-speed scan region can be controlled very precisely. During the scan motion of the stages relative to the projection optical system 97, the reticle pattern is projected onto to the wafer, whereby the circuit pattern is transferred to the latter.

This embodiment uses a stage system according to any one of the preceding embodiment as the stage structure. As a result, an interferometer error resulting from fluctuation in the air can be reduced as much as possible, without disturbing the stage motion. Thus, mixture of noises to the interferometer is reduced, and therefore a high-speed and high-precision exposure process is accomplished.

Next, an embodiment of a semiconductor device manufacturing method which uses an exposure apparatus such as described above, will be explained.

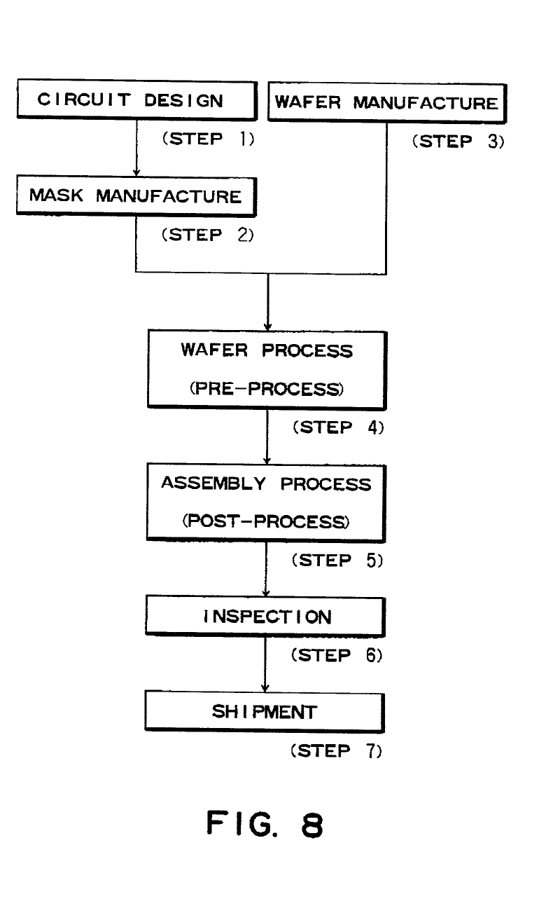

FIG. 8 is a flow chart of procedure for manufacture of microdevices such as semiconductor chips (e.g. ICs or LSIs), liquid crystal panels, or CCDs, for example.

Step 1 is a design process for designing a circuit of a semiconductor device. Step 2 is a process for making a mask on the basis of the circuit pattern design. Step 3 is a process for preparing a wafer by using a material such as silicon. Step 4 is a wafer process (called a pre-process) wherein, by using the so prepared mask and wafer, circuits are practically formed on the wafer through lithography. Step 5 subsequent to this is an assembling step (called a post-process) wherein the wafer having been processed by step 4 is formed into semiconductor chips. This step includes an assembling (dicing and bonding) process and a packaging (chip sealing) process. Step 6 is an inspection step wherein operation check, durability check and so on for the semiconductor devices provided by step 5, are carried out. With these processes, semiconductor devices are completed and they are shipped (step 7).

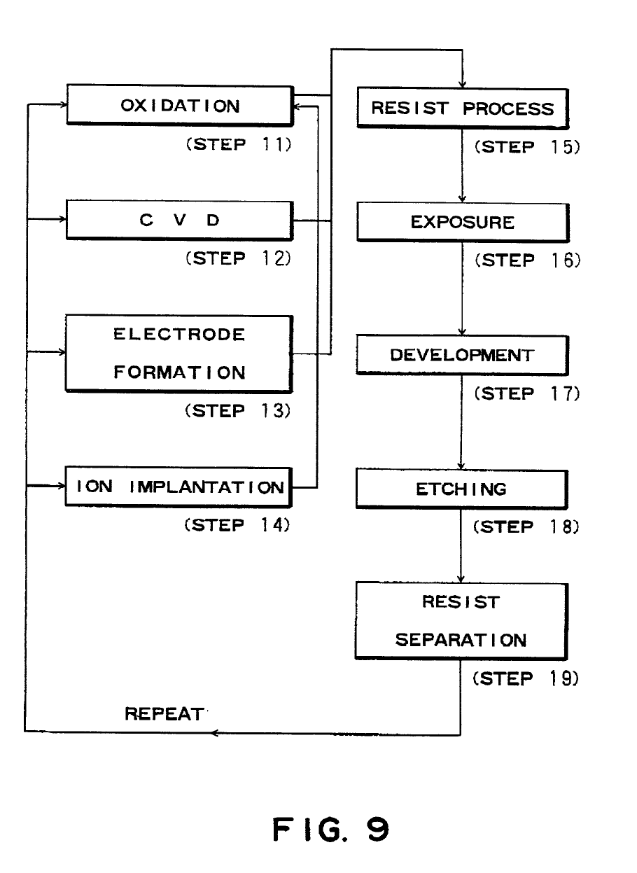

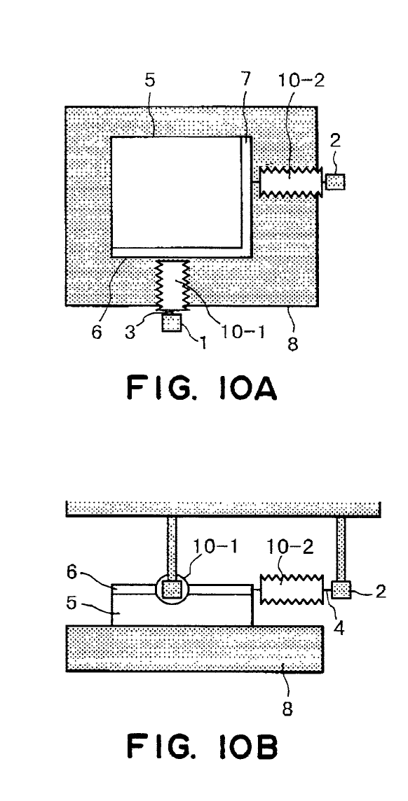

FIG. 9 is a flow chart showing details of the wafer process.

Step 11 is an oxidation process for oxidizing the surface of a wafer Step 12 is a CVD process for forming an insulating film on the wafer surface. Step 13 is an electrode forming process for forming electrodes upon the wafer by vapor deposition. Step 14 is an ion implanting process for implanting ions to the wafer. Step 15 is a resist process for applying a resist (photosensitive material) to the wafer. Step 16 is an exposure process for printing, by exposure, the circuit pattern of the mask on the wafer through the exposure apparatus described above. Step 17 is a developing process for developing the exposed wafer. Step 18 is an etching process for removing portions other than the developed resist image. Step 19 is a resist separation process for separating the resist material remaining on the wafer after being subjected to the etching process. By repeating these processes, circuit patterns are superposedly formed on the wafer.

With these processes, high density microdevices can be manufactured.

In accordance with the present invention, any fluctuation in an air along an interferometer light path is reduced, such that mixture of noises into the interferometer can be reduced significantly. This effectively reduces an error involved in an interferometer measured value, such that further improvements in precision of a projection exposure apparatus, for example, is accomplished.

While the invention has been described with reference to the structures disclosed herein, it is not confined to the details set forth and this application is intended to cover such modifications or changes as may come within the purposes of the improvements or the scope of the following claims.

What is claimed is:

1. A stage system, comprising:
a movable stage;
a gas blowing port for blowing a gas in a predetermined direction;
a mirror disposed on said stage;
a laser interferometer for projecting measurement light to said mirror, to measure a position of said stage; and
a member disposed between said gas blowing port and a measurement light path of said laser interferometer, to block a portion of a gas flow from said gas blowing port.

2. A stage system according to claim 1, wherein said member is operable to stabilize fluctuation at the measurement light path of said laser interferometer.

3. A stage system according to claim 1, wherein said stage moves in an ambience in which a gas is blown in a predetermined direction.

4. A stage system according to claim 1, wherein said gas blowing port functions to flow a gas in a direction out of parallel to a plane along which said stage is movable.

5. A stage system according to claim 1, wherein said member is operable to prevent that the gas flow from said gas blowing port directly flows into the measurement light path.

6. A stage system according to claim 1, wherein said member has one of a semi-cylindrical shape and a planar shape.

7. A stage system according to claim 1, wherein said member has a bore.

8. A stage system according to claim 1, wherein said member has one of a structure defined by a combination of fine tubular elements and a structure having partitions defined by flat plates.

9. A stage system according to claim 1, wherein a flow rate of a gas flow across the measurement light path of said laser interferometer is smaller than that of a gas flow in an ambience.

10. A stage system according to claim 1, wherein the direction of the gas flow from said gas blowing port is inclined with respect to a plane along which said stage is movable.

11. A stage system, comprising:
a movable stage;
a gas blowing port for blowing a gas in a predetermined direction;
a mirror disposed on said stage;
a laser interferometer for projecting measurement light to said mirror, to measure a position of said stage; and
a member arranged to produce a difference between a flow rate of a gas flow in an ambience as provided by said gas blowing port and a flow rate of a gas flow across a measurement light path of said laser interferometer.

12. A stage system according to claim 11, wherein said member is operable to stabilize fluctuation at the measurement light path of said laser interferometer.

13. A stage system according to claim 11, wherein said stage moves in an ambience in which a gas is blown in a predetermined direction.

14. A stage system according to claim 11, wherein said gas blowing port functions to flow a gas in a direction out of parallel to a plane along which said stage is movable.

15. A stage system according to claim 11, wherein said member is operable to prevent that the gas flow from said gas blowing port directly flows into the measurement light path.

16. A stage system according to claim 11, wherein said member has one of a semi-cylindrical shape and a planar shape.

17. A stage system according to claim 11, wherein said member has a bore.

18. A stage system according to claim 11, wherein said member has one of a structure defined by a combination of fine tubular elements and a structure having partitions defined by flat plates.

19. A stage system according to claim 11, wherein a flow rate of a gas flow across the measurement light path of said laser interferometer is smaller than that of a gas flow in an ambience.

20. A stage system according to claim 11, wherein the direction of the gas flow from said gas blowing port is inclined with respect to a plane along which said stage is movable.

21. A stage system, comprising:
a movable stage;
a gas blowing port for blowing a gas in a predetermined direction;
a mirror disposed on said stage;
a laser interferometer for projecting measurement light to said mirror, to measure a position of said stage; and
a member disposed between said gas blowing port and a measurement light path of said laser interferometer, wherein said member has a temperature adjusted structure.

22. A system according to claim 21, wherein said member is adjusted at a constant temperature.

23. A stage system according to claim 21, wherein said member is operable to stabilize fluctuation at the measurement light path of said laser interferometer.

24. A stage system according to claim 21, wherein said stage moves in an ambience in which a gas is blown in a predetermined direction.

25. A stage system according to claim 21, wherein said gas blowing port functions to flow a gas in a direction out of parallel to a plane along which said stage is movable.

26. A stage system according to claim 21, wherein said member is operable to prevent that the gas flow from said gas blowing port directly flows into the measurement light path.

27. A stage system according to claim 21, wherein said member has one of a semi-cylindrical shape and a planar shape.

28. A Stage system according to claim 21, wherein said member has a bore.

29. A stage system according to claim 21, wherein said member has one of a structure defined by a combination of fine tubular elements and a structure having partitions defined by flat plates.

30. A stage system according to claim 21, wherein a flow rate of a gas flow across the measurement light path of said laser interferometer is smaller than that of a gas flow in an ambience.

31. A stage system according to claim 21, wherein the direction of the gas flow from said gas blowing port is inclined with respect to a plane along which said stage is movable.

32. An exposure apparatus, comprising:
a movable stage;
a gas blowing port for blowing a gas in a predetermined direction;
a mirror disposed on said stage;
a laser interferometer for projecting measurement light to said mirror, to measure a position of said stage; and
a member disposed between said gas blowing port and a measurement light path of said laser interferometer, to block a portion of a gas flow from said gas blowing port.

33. An exposure apparatus, comprising:
a movable stage;
a gas blowing port for blowing a gas in a predetermined direction;
a mirror disposed on said stage;
a laser interferometer for projecting measurement light to said mirror, to measure a position of said stage; and
a member arranged to produce a difference between a flow rate of a gas flow in an ambience as provided by said gas blowing port and a flow rate of a gas flow across a measurement light path of said laser interferometer.

34. An exposure apparatus, comprising:
a movable stage;
a gas blowing port for blowing a gas in a predetermined direction;
a mirror disposed on said stage;
a laser interferometer for projecting measurement light to said mirror, to measure a position of said stage; and
a member disposed between said gas blowing port and a measurement light path of said laser interferometer, wherein said member has a temperature adjusted structure.

35. A device manufacturing method, comprising the steps of:
preparing an exposure apparatus as recited in claim 32; and
exposing a substrate by use of the exposure apparatus.

36. A device manufacturing method, comprising the steps of:
preparing an exposure apparatus as recited in claim 33; and
exposing a substrate by use of the exposure apparatus.

37. A device manufacturing method, comprising the steps of:
preparing an exposure apparatus as recited in claim 34; and
exposing a substrate by use of the exposure apparatus.
